(19) United States
(12) Patent Application Publication
(10) Pub. No.: US 2024/0262732 A1
(43) Pub. Date: Aug. 8, 2024

(54) CLEAN WATER EXTRACTION AND PURIFICATION SYSTEM AND METHOD

(71) Applicant: Danny E. Rogers, Chula Vista, CA (US)

(72) Inventor: Danny E. Rogers, Chula Vista, CA (US)

(21) Appl. No.: 18/435,538

(22) Filed: Feb. 7, 2024

Related U.S. Application Data
(60) Provisional application No. 63/443,816, filed on Feb. 7, 2023.

(51) Int. Cl. C02F 9/20; B01D 39/20; C02F 1/00; C02F 1/02; C02F 1/28; C02F 1/66; C02F 101/10

(52) U.S. Cl. CPC C02F 9/20; B01D 39/20; C02F 1/001; C02F 1/02; C02F 1/281; C02F 1/283; C02F 1/285; C02F 1/66; C02F 2101/10; C02F 2201/008

(57) ABSTRACT

A system and process for extracting clean water from natural water flow sources or from man-made solutions. The system uses a series of steps, including multiple cleaning and multiple collecting agents. This system for water purification does not require the use of any toxic or acidic chemicals. The water source is tapped into by a purification recovery unit which passes through five stages: cleaning, treating, collection, contaminant extraction, and finally exported clean water for its final desired end use.

### CROSS-REFERENCE TO RELATED APPLICATION

This application claims priority in U.S. Provisional Patent Application No. 63/443,816 Filed Feb. 7, 2023, which is incorporated herein by reference.

### BACKGROUND OF THE INVENTION

### 1. Field of the Invention

The present invention relates generally to a water cleaning system and method for use thereof, and more specifically to a water extraction and purification system employing multiple steps.

### 2. Description of the Related Art

Clean water, whether for consumption or for other uses, is a highly desirable commodity. Many times water becomes contaminated due to industry activity, natural disasters, or otherwise is unusable for one or more purposes. Existing methods attempt to clean and purify such water, but typically these systems and methods apply to limited situations and cannot clean water while recovering the contaminants and impurities to dispose of. No product currently can take any water source and produce water for any desired level of purity.

Heretofore there has not been available a system or method for water extraction and purification with the advantages and features of the present invention.

### BRIEF SUMMARY OF THE INVENTION

The present invention generally a system and process for extracting clean water from natural water flow sources or from man-made solutions. The system uses a series of steps, including multiple cleaning and multiple collecting agents. This system for water purification does not require the use of any toxic or acidic chemicals. The water source is tapped into by a purification recovery unit which passes through five stages: cleaning, treating, collection, contaminant extraction, and finally exported clean water for its final desired end use.

Stage 1 includes a variety of filtering agents. These can include sand, gravel, diatomaceous earth and other filtering agents to remove contaminants from the water. The filtering agents can vary depending on the type of contamination.

Stage 2 is the next step, where the water is prepared. This process can incorporate an acid or base treatment to balance the water to a pH of around 7.0. The water can also be diverted to a heater or chiller to heat or cool the water, depending on desired temperatures.

Stage 3 follows, where the water flows into the collecting agents. These collecting agents vary, depending on need, and may include charcoal, steel wool, resins, or other collecting agents for pulling contaminants from the water.

At stage 4, the contaminants which may include base metals, salts, etc. all the way to precious metals are extracted from the collection agents. This extraction method can also vary, including firing the collecting agents in an oven, elution, or even refining the agents in a refinery. This is all in an effort to recover and safely extract the contaminates and dispose of them or use them in an environmentally friendly manner.

Once this is accomplished, stage 5 presents the processed water through any final water finishing and then deposits the purified water wherever it is desired-in tanks, into a municipal water system, or even back into an aquifer.

### BRIEF DESCRIPTION OF THE DRAWINGS

The drawings constitute a part of this specification and include exemplary embodiments of the present invention illustrating various objects and features thereof.

FIG. 1 is a diagrammatic representation of a preferred embodiment of the present invention.

FIG. 2 is a side elevational view with a cutout showing an example of the preferred embodiment as stored in a typical environment of a trailer.

FIG. 3A is a flowchart diagramming the steps taken in practicing the embodiment thereof.

FIG. 3B is a flowchart continuing from FIG. 3A.

FIG. 3C is a flowchart continuing from FIG. 3B.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Water Purification System 2

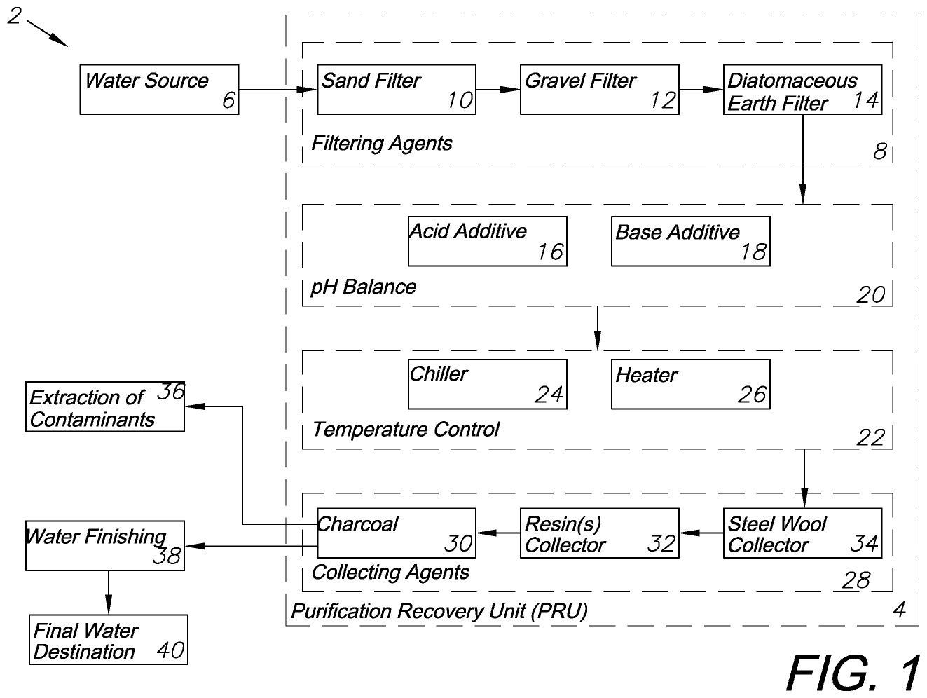

As shown in the figures, the present invention is a water purification system 2 utilizing a purification recovery unit purification recovery unit (“PRU”) 4 with several process steps involved. FIG. 1 shows a diagrammatic representation of a water purification system 2 utilizing a PRU 4 which could be any structure or area dedicated to storing the equipment necessary for the process steps.

A water source 6 provides water supplied to the PRU 4. The first stage of the PRU is the filtering agents 8 stage. Here, the water is run through one or more filters to remove large particles and elements that can easily be filtered out. For example, a sand filter 10, gravel filter 12, and diatomaceous earth (“D.E.”) filter 14 could be stacked and the water can be run through one or more of these filters. These filters can be replaced as needed, and additional filters may be included as needed.

The second stage is a water treatment stage. The filtered water may need to have its pH balanced. If so, the water is sent through the pH Balance subsystem 20 where it can either be treated with an acid additive 16 or a base additive 18, depending on how the pH needs to be adjusted. The water may further need to be treated by adjusting its temperature. A temperature control subsystem 22 may include a chiller 24 and heater 26 which can adjust the temperature of the water as needed.

The third stage of the water purification system 2 is a collecting agent subsystem 28 which collects contaminants from the water, such as base metals, salts, precious metals and other elements. The collection agents of the collecting agent subsystem 28 pull these elements from the water and store them within the collecting agents themselves. Examples include charcoal collecting agents 30, resin colleting agents 32, and steel wool collecting agents 34. Each collecting agent may be designed to pull different types of contaminates from the water.

Once these contaminates are pulled from the water using the collecting agent subsystem 28, the contaminants are extracted from the collection agents 30, 32, 34. This extraction method can also vary, including firing the collecting agents in an oven, elution, or even refining the agents in a refinery. This is all in an effort to recover and safely extract the contaminates 36 and dispose of them or use them in an environmentally friendly manner. This step may take place off-site from the PRU, but may occur within the PRU as well.

Once this is accomplished, stage 5 presents the processed water through any final water finishing 38 and then deposits 40 the purified water wherever it is desired—in tanks, into a municipal water system, or even back into an aquifer.

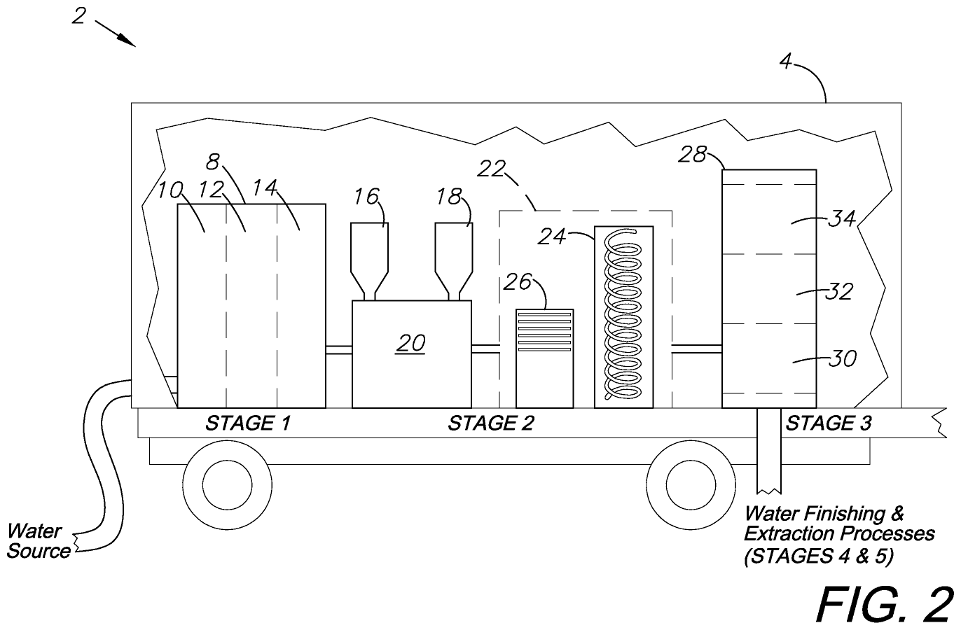

FIG. 2 shows how this water purification system 2 could be installed in a vehicle, such as a trailer, which functions as the PRU 4. As above, the water finishing and collecting agent reclamation steps could be performed within the PRU or off site.

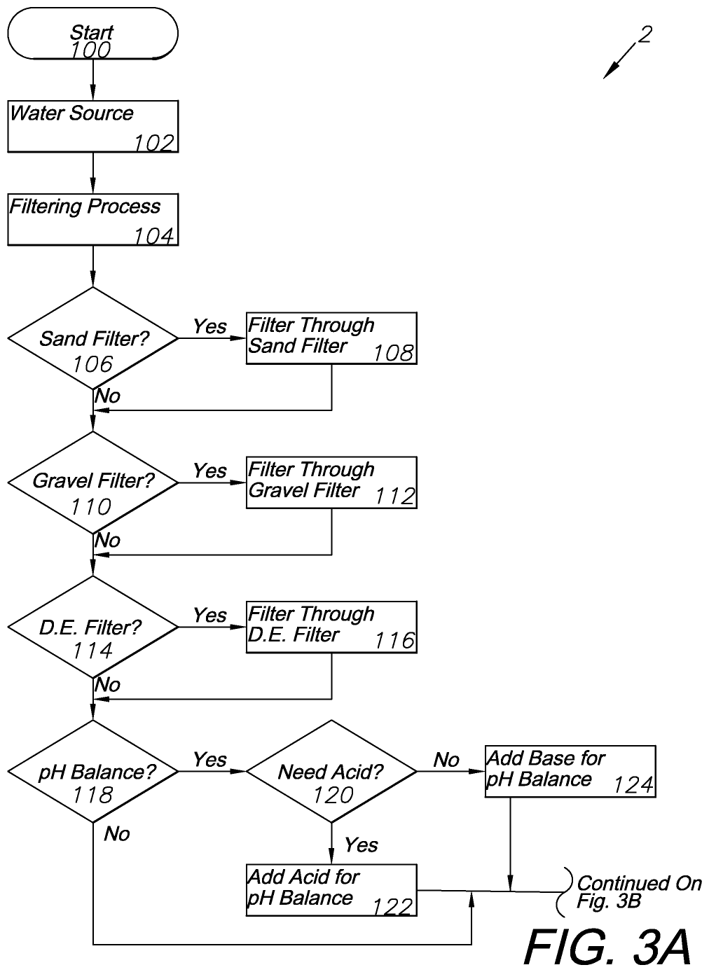

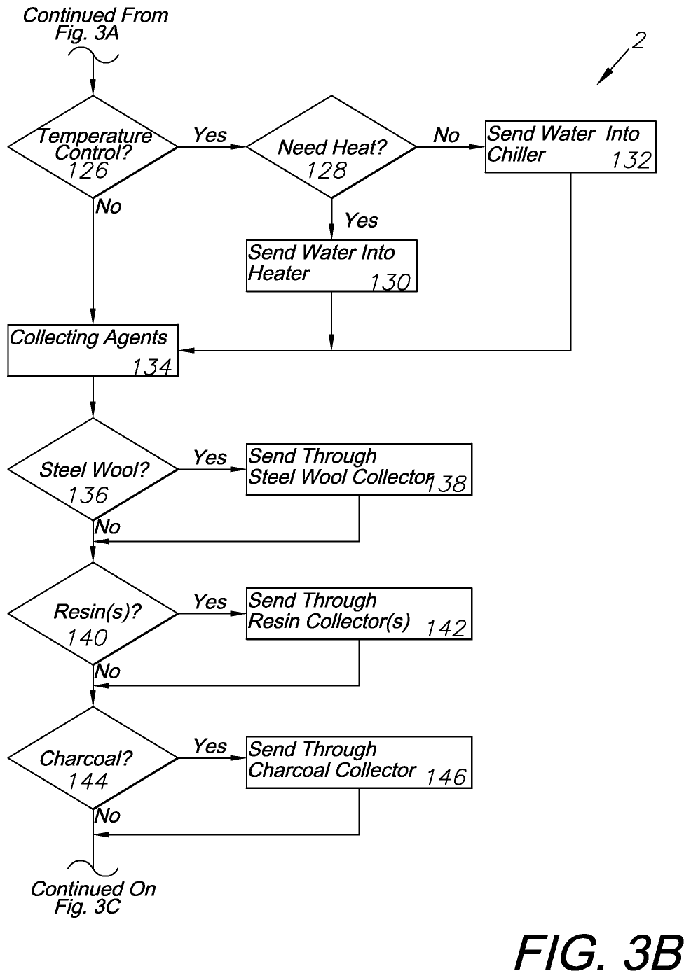

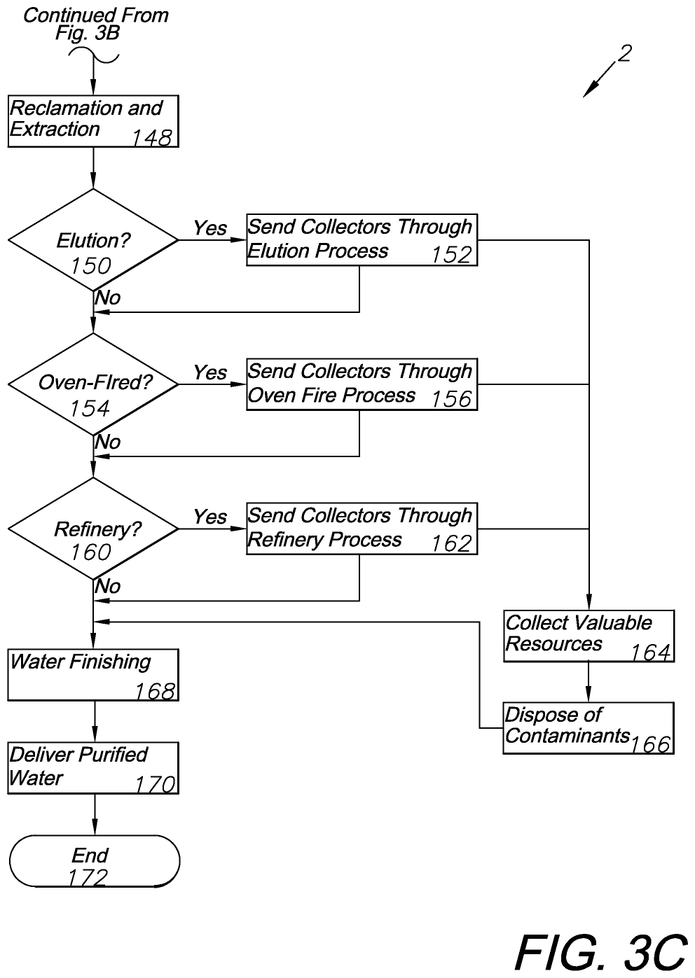

FIGS. 3A-3C show steps taken in practicing a preferred embodiment of the present invention. As shown in FIG. 3A, the process starts at 100. A water source is selected at 102 and the water is directed through the filtering process at 104, which is within the PRU 4. As discussed above, these filters may differ depending on a case-by-case scenario. For a preferred embodiment example, a determination is made at 106 by the water purification system 2 whether a sand filter is needed. If yes, the water is filtered through the sand filter at 108. Next, a determination is made at 110 by the water purification system 2 whether a gravel filter is needed. If yes, the water is filtered through the gravel filter at 112. Similarly, a determination is made at 114 by the water purification system 2 whether a D.E. filter is needed. If yes, the water is filtered through the D.E. filter at 116. This is the stage one filtering process complete.

Next, the water may need to be treated. This can all be skipped if treatment is not necessary, but typically water needs to be treated in some manner. First, a determination is made by the water purification system 2 at 118 whether the pH of the water needs to be adjusted for the water's final determined use. If yes, if acid is needed at 120, acid is added at 122; otherwise, a base is added at 124 and the process continues at 3B.

Similarly, the water's temperature may need to be adjusted depending on its final determined use and potentially to maximize the contaminate extraction at the next stage. The system 2 will determine whether the temperature needs to be controlled at 126. If yes, and if the determination is that heat is needed at 128, the water is sent to a heater unit at 130 which warms the water. Alternatively, the water is sent into a chiller 132 to cool the water.

After this, stage three begins. Here, the water is sent through collecting agents at 134 to remove contaminates, such as metals, salts, and other elements. Different collecting agents may be used, but in a preferred embodiment the process continues through to determine if a steel wool collecting agent is needed at 136. If yes, the water is sent through a steel wool collector at 138, which draws contaminates out of the water and stores them within the steel wool. Similarly, the system 2 determines if one or more resins as collecting agents are needed at 140. If yes, the water is sent through one or more resin collectors at 142, which draws contaminates out of the water and stores them within the resin. Finally, the system 2 determines if a charcoal collecting agent is needed at 144. If yes, the water is sent through the charcoal collecting agent 146, which draws contaminates out of the water and stores them within the charcoal.

The process then continues onto FIG. 3C. Here, the fourth stage which is the reclamation and extraction step 148 begins. Different extraction methods may be used to remove the contaminates, metals, salts, and other elements from the collecting agents. In a preferred embodiment as shown here, the system 2 determines whether an elution extraction is needed at 150. If yes, the collectors are sent through an elution extraction system at 152. Similarly, the system 2 determines whether an oven-fired extraction is needed at 154. If yes, the collectors are sent through an oven at 156 which burns off the collecting agent and unnecessary materials, leaving behind anything desired to be collected. Finally, the system 2 determines whether a refinery extraction is needed at 160. If yes, the collectors are sent to a refinery at 162 to remove the elements from the collecting agents to collect anything valuable. From there, all valuable resources are collected at 164 and everything else is disposed of at 166.

Finaly, step five of the system is the water finishing step at 168. As above, this step could be performed in the PRU or somewhere else offsite. This final water finishing deposits the purified water wherever it is desired—in tanks, into a municipal water system, or even back into an aquifer at 170. The process then ends at 172.

It is to be understood that while certain embodiments and/or aspects of the invention have been shown and described, the invention is not limited thereto and encompasses various other embodiments and aspects.

1. A water purification system comprising:
a water source delivering water to a purification recovery unit;
said purification recovery unit comprising a filtering agent subsystem, a water treatment subsystem, and a collecting agent subsystem;
said filtering agent subsystem consisting of at least one filtering agent configured to remove foreign elements from said water;
said water having a base temperature and a base pH level;
said water treatment subsystem configured to adjust the temperature of said water from said base temperature to a preferred temperature;
said water treatment subsystem further configured to adjust the pH level of said water from said base pH level to a preferred pH level;
said collecting agent subsystem comprising at least one collecting agent configured to remove additional foreign elements from said water; and
whereby purified water is delivered to a desired destination.

2. The water purification system of claim 1, wherein said at least one filtering agent selected from a filtering agent comprising: sand; gravel; and diatomaceous earth.

3. The water purification system of claim 1, wherein said at least one filtering agent comprising a first filter comprised of sand, a second filter comprised of gravel, and a third filter comprised of diatomaceous earth.

4. The water purification system of claim 1, wherein said collecting agent subsystem comprises an acid pH additive, a base pH additive, a chiller, and a heater.

5. The water purification system of claim 1, wherein said at least one collecting agent selected from a collecting agent comprising: steel wool; resin; and charcoal.

6. The water purification system of claim 1, wherein said at least one collecting agent comprising a first collecting agent comprised of steel wool, a second collecting agent comprised of resin, and a third collecting agent comprised of charcoal.

7. The water purification system of claim 1, wherein said purification recovery unit comprises a mobile housing capable of moving said water purification system to another site.

8. The water purification system of claim 1, further comprising:
an extraction subsystem, and a water finishing subsystem;
said extraction subsystem configured to remove said additional foreign elements from said at least one collecting agent; and
said water finishing subsystem configured to finish said water fore final delivery to said desired destination.

9. The water purification system of claim 8, wherein said extraction subsystem is selected from a list of subsystems comprising: elution; oven-fired; and a refinery.

10. A method of purifying water, the method comprising:
providing a water source;
collecting water from said water source and sending said water to a purification recovery unit;
filtering said water through a filtering subsystem within said purification recovery unit;
treating said water by adjusting a pH level of said water;
treating said water by adjusting a temperature of said water;
collecting contaminates from said water via a collecting agent subsystem; and
thereby delivering purified water.

11. The method of claim 10, further comprising the steps:
filtering said water through a first filter of said filtering subsystem, wherein said first filter comprises sand;
filtering said water through a second filter of said filtering subsystem, wherein said second filter comprises gravel; and
filtering said water through a third filter of said filtering subsystem, wherein said third filter comprises diatomaceous earth.

12. The method of claim 11, further comprising the steps:
adjusting said pH level of said water by providing an additive selective from the list comprising: an acidic additive; and a basic additive.

13. The method of claim 11, further comprising the steps:
adjusting said temperature of said water by sending said water through a device selected from the list comprising: a chiller; and a heater.

14. The method of claim 13, further comprising the steps:
sending said water through a first collecting agent of said collecting agent subsystem, wherein said first collecting agent comprises steel wool;
sending said water through a second collecting agent of said collecting agent subsystem, wherein said second collecting agent comprises resin; and
sending said water through a third collecting agent of said collecting agent subsystem, wherein said third collecting agent comprises charcoal.

15. The method of claim 14, further comprising the steps:
finishing said water for a final desired use; and
extracting contaminates from said collecting agents.

16. The method of claim 15, wherein extracting said contaminates comprises an extraction process selected from the list comprising: elution; oven firing; and refining.
